(19) United States
(12) Patent Application Publication
(10) Pub. No.: US 2018/0042165 A1
(43) Pub. Date: Feb. 15, 2018

(54) Hardpan Apparatus

(71) Applicants: JACK JANZEN, Kincardine (CA); STANLEY JANZEN, Kincardine (CA)

(72) Inventors: JACK JANZEN, Kincardine (CA); STANLEY JANZEN, Kincardine (CA)

(21) Appl. No.: 15/669,131

(22) Filed: Aug. 4, 2017

Related U.S. Application Data
(60) Provisional application No. 62/374,096, filed on Aug. 12, 2016.

(51) Int. Cl. A01B 35/16; A01B 49/02; A01B 35/32; A01B 29/04; A01B 35/28; A01B 63/22; A01B 29/06

(52) U.S. Cl. CPC A01B 35/16; A01B 63/22; A01B 49/027; A01B 29/06; A01B 29/04; A01B 35/28; A01B 35/32; A01B 19/00

(57) ABSTRACT

An apparatus for breaking up the hardpan subsoil layer of agricultural land has a wheeled frame adapted to connect to a tractor. A roller is rotatably mounted within the frame. A plurality of spike members are attached to the circumferential face of the roller and extend outwardly therefrom beneath the frame for penetrating engagement with the hardpan subsoil layer, to thereby break up the hardpan.

### CROSS-REFERENCE TO RELATED APPLICATIONS

This application claims the benefit of U.S. provisional patent application no. 62/374,096, filed Aug. 12, 2016, the entire contents of which are incorporated herein by reference.

### FIELD OF THE INVENTION

The present invention relates to machinery and apparatus for breaking up soil layers in agriculture. In particular, it relates to machinery and apparatus for breaking up the hardpan subsoil layer.

### BACKGROUND

Soil compaction on agricultural land is a growing concern, due to the increasing size and weight of tractors and other farm equipment. Wheel traffic from heavy farm equipment, particularly while the soil is wet, is generally accepted to be the main cause of soil compaction. Over time, soil compaction causes the development of a dense subsoil layer, known as the “hardpan” or the “hardpan layer”. This can reduce the water infiltration and drainage of the soil and impede root growth, resulting in reduced crop yields. Soil compaction at the surface layer can also increase runoff, resulting in increased erosion and water loss.

One approach to minimizing the effects of soil compaction is to control field traffic, so as to minimize the amount of compaction that occurs. However, it is not always possible to avoid driving heavy equipment over the soil, during times when the soil is particularly susceptible to compaction, such as when it is wet. Further, once subsoil compaction has occurred, its effects can last for years. Accordingly, techniques for remediating subsoil compaction are required.

Traditionally, agricultural land suffering from subsoil compaction is treated using devices known as “rippers” or “deep rippers”, which use large tines that slice through the soil to the desired depth in order to break apart the hardpan. However, the effectiveness of these devices is highly variable.

### SUMMARY OF THE INVENTION

An apparatus for breaking up the hardpan subsoil layer of agricultural land, according to the present invention, has a wheeled frame adapted to connect to a tractor for towing over the agricultural land. A roller having a circular cross-section, a length, a circumferential face, and opposing sidewalls is rotatably mounted within the frame. A plurality of spike members are attached to the circumferential face of the roller and extend outwardly therefrom beneath the frame for penetrating engagement with the hardpan subsoil layer.

The roller rotates, in response to the forward motion of the frame, as the apparatus is pulled behind the tractor, causing the spikes to penetrate the soil and the subsoil hardpan layer, thereby breaking up the hardpan.

In another embodiment, the plurality of spike members are arranged on the circumferential face of the roller in rows between the sidewalls.

In another embodiment, the rows are helical rows.

In another embodiment, each spike member is fitted within a collar, which is fixedly attached to the circumferential face, and is attached thereto by means of a shear pin.

In another embodiment, each spike member is equidistantly spaced apart from each adjacent spike member in the rows and one or more scraper devices are mounted on the frame and aligned with the equidistant spaces between the spike members. The scraper devices have a scraper blade positioned adjacent the circumferential face and spaced apart therefrom.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a perspective view of the hardpan apparatus, according to the present invention.

FIG. 2 is a side view of the hardpan apparatus.

FIG. 3 a side view of the roller of the hardpan apparatus, showing the rows of spikes thereon.

FIG. 4 is a detail view of the scraper devices, showing the scraper blades positioned adjacent the roller in the space between adjacent spikes.

FIG. 5 is a detail view of the rear end of the frame of the hardpan apparatus, showing the adjustable ride height system.

FIG. 6 is a detail view of the parking stand at the front of the frame.

FIG. 7 is a side view of the hardpan apparatus, being pulled by a tractor.

FIG. 8 is a side view of a spike below the roller, shown penetrating the hardpan subsoil layer.

### DESCRIPTION OF THE PREFERRED EMBODIMENT

The hardpan apparatus, according to the present invention, is used to break up compacted soils, for example the hardpan subsoil layer. The apparatus comprises a roller penetrating device, or roller, which is mounted within a wheeled frame, designed to be towed behind a tractor that provides the towing power for the apparatus. The frame is constructed to be open at the bottom to permit engagement of the roller with the ground surface. The wheels on the frame are retractable to thereby fully engage the roller with the ground surface.

When the hardpan apparatus is drawn over a field, a plurality of spikes on the roller pierce, disturb, and loosen the soil to allow growing plant roots to grow down into mellow, organic, productive soil. The hardpan apparatus, when drawn over a field, also leaves an organized pattern of penetrated impressions in the soil allowing moisture to move vertically and horizontally through the soil, thereby reducing runoff.

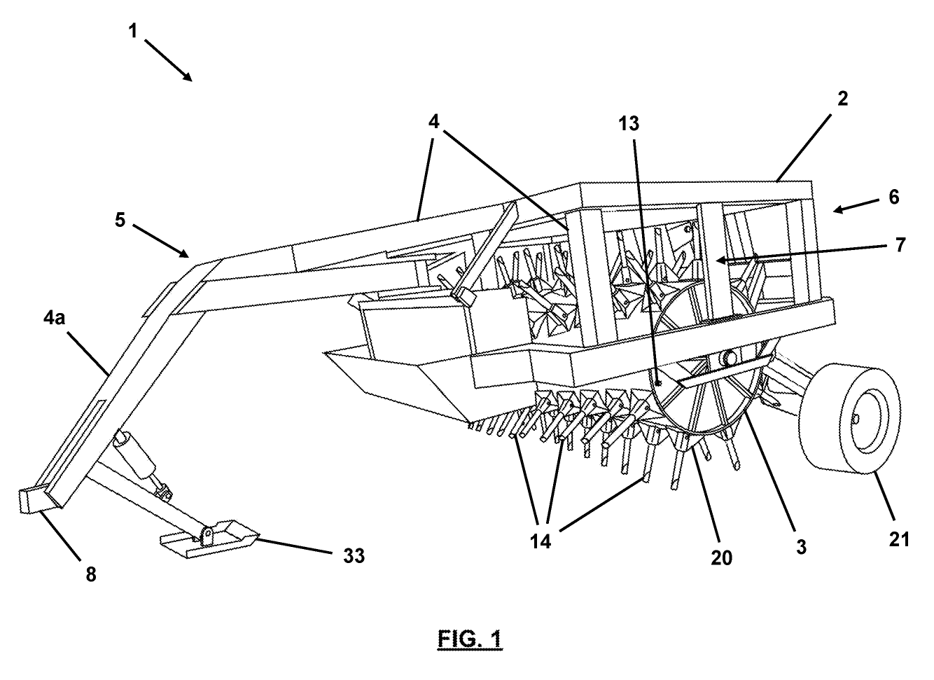

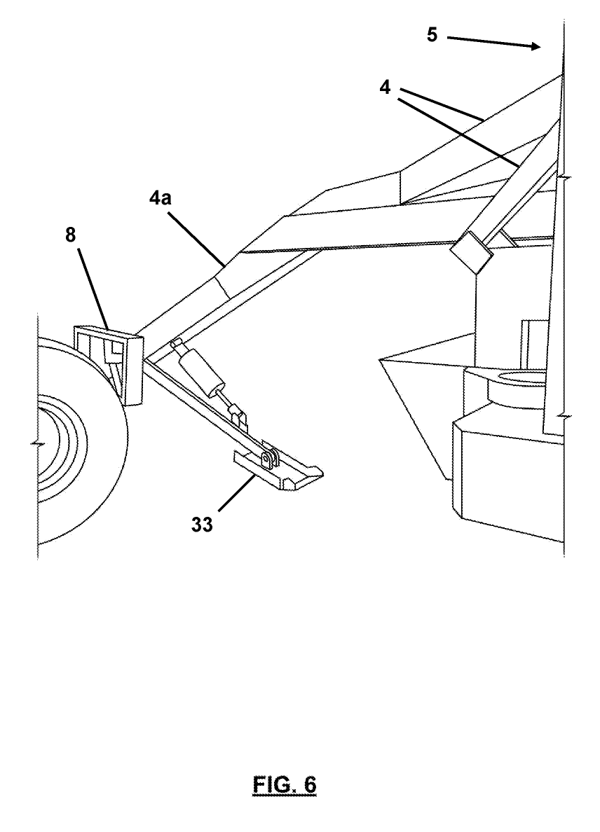

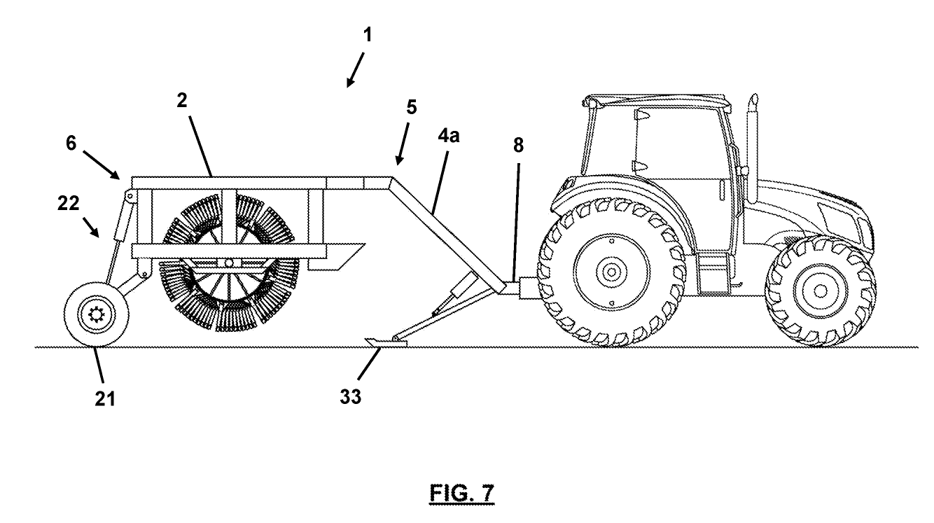

As shown in FIG. 1, the hardpan apparatus 1 has a wheeled frame 2 and a roller 3, rotatably mounted within the frame 2. The frame 2 has a plurality of structural members 4, a front end 5, a rear end 6, and sides 7. The plurality of structural members 4 are arranged to provide attachment points for the roller 3 and to give rigidity to the frame 2. On the front end 5 of the frame 2 is a linkage 8 for connecting the frame 2 to a tractor. As is known in the art, any suitable linkage may be used, for example, a drawbar hitch or three-point hitch. As shown in FIGS. 1, 2, 6, and 7, a tongue 4a extends forwardly from the front end 5 of the frame 2 and may also angle downwardly at its forward-most end to provide an optimum connection point with the tractor. Preferably, the linkage 8 is located at the end of the tongue 4a.

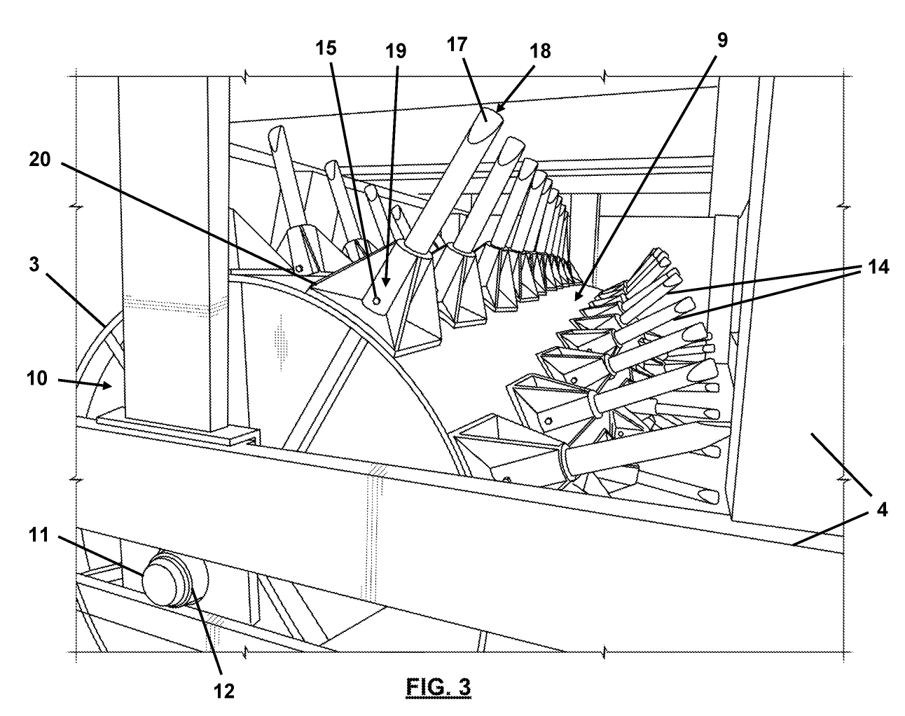

The roller 3 is cylindrical having a circumferential face 9 and opposing sidewalls 10. As shown in FIG. 3, the roller 3 is mounted within the frame 2 by way of axles 11, between the sides 7 and intermediate the front and rear ends 5 and 6 of the frame 2. The axles 11 extend outwardly from the centre of the opposing sidewalls 10 and are seated within rotary bearings 12 attached to the sides 7 of the frame 2. The roller 3 is thereby permitted to rotate freely about its longitudinal axis. Preferably, the roller 3 is hollow with one or more hollow compartments that may be filled with liquid weight ballast, typically water, through an aperture 13 in one of the sidewalls 10, to add weight as required. Weight ballast, may also be added on a platform (not shown) on top of the frame 2. Optionally, a brake mechanism (not shown) may be provided to prevent rotation of the roller 3 when the hardpan apparatus 1 is not in use and for safety purposes.

A plurality of elongated spike members, or spikes 14, are mounted on the circumferential face 9 of the roller 3 and extend radially outwardly therefrom and beneath the frame 2 for penetrating engagement with the hardpan subsoil layer. The spikes 14 are attached to the circumferential face 9 by way of shear pins 15 to minimize damage to the hardpan apparatus 1 in the event one of the spikes 14 hits a rock or other debris during operation. In that event, the spike 14 will shear the shear pin 15 at the connection point and detach. At least a portion of each spike 14 may be coloured to assist in locating any detached or broken spikes 14 in the field. The spikes 14 are arranged about the circumferential face 9 of the roller 3 in rows 16, across the surface of the roller 3.

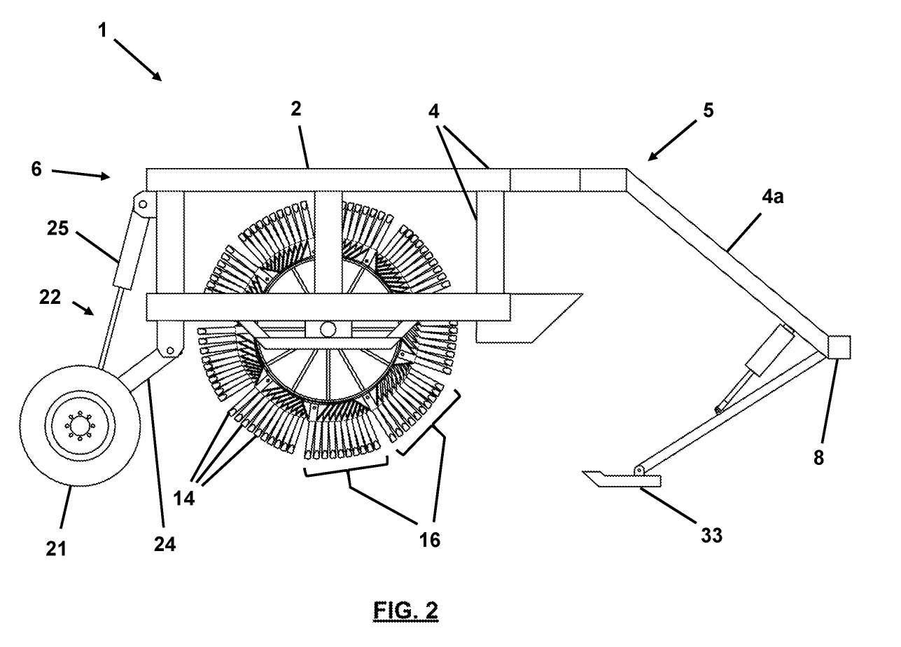

In the preferred embodiment, there are nine rows 16 of ten spikes 14 arranged about the roller 3, however, fewer or additional rows 16 of spikes 14 may be used. As shown in FIGS. 2, 3, and 4, the spikes 14 in each row 16 are equidistantly spaced apart from each adjacent spike and may be slightly circumferentially offset from one another, thereby providing the roller 3 with helical rows 16 of spikes 14. For example, each spike 14 may be offset from the adjacent spikes 14 by 1″ along the circumferential face 9 of the roller 3. This promotes the penetration of the spikes 14 into the soil and more evenly distribute the penetrating forces exerted by the spikes 14 on the ground beneath. This in turn reduces “bumping”, since not all of the spikes 14 in each row 16 engage with the soil simultaneously. Preferably, as the roller 3 rotates, only one spike 14 (at bottom dead-centre) is fully engaged with the soil at any given time and the adjacent spikes 14 in the row 16 are either entering or exiting the soil.

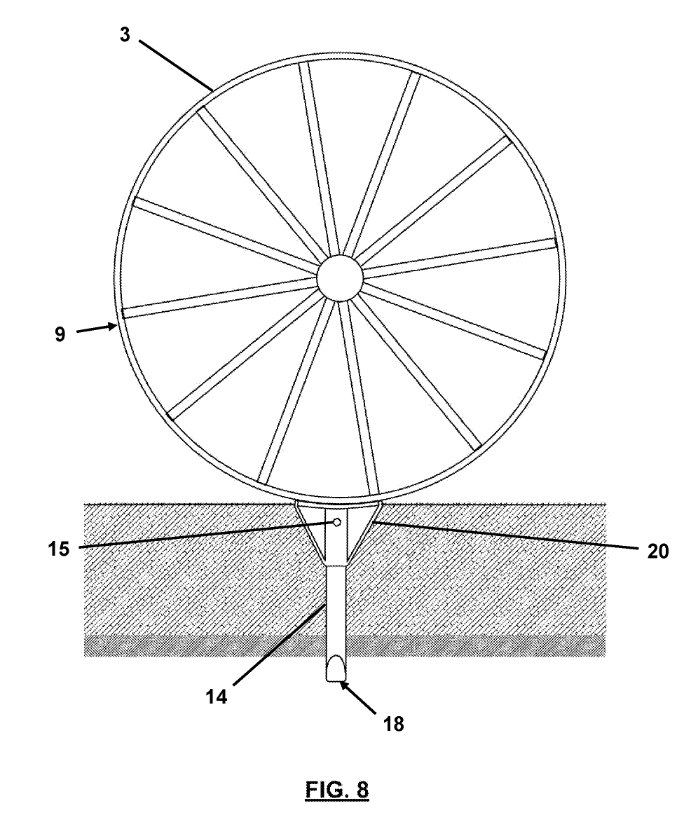

The spikes 14 are, preferably, between 16″ and 20″ long. The spikes 14 must be long enough to penetrate the hardpan, which is typically about 8″-9″ below the surface of the soil, as shown in FIG. 8. The illustration in FIG. 8 conceptually shows the hardpan and a spike 14 penetrating therethrough. The hardpan layer generally forms about 1″ below the penetration depth of the tillage instruments used on the soil. Spike length may be selected, based on soil conditions, in particular, the depth of the hardpan layer, as determined, for example, by a survey of the field.

As shown in FIGS. 2-4, the spikes 14 extend radially outwardly from the circumferential face 9 of the roller 3 and are cylindrical with a generally round cross-section and a wedge-like point 17 at the distal end 18 (the end pointing away from the roller 3). The other end, or proximal end 19, of each spike 14 is fitted within a collar 20 and attached to the collar 20 by way of a shear pin 15, while the collar 20 is welded to the circumferential face 9 of the roller 3.

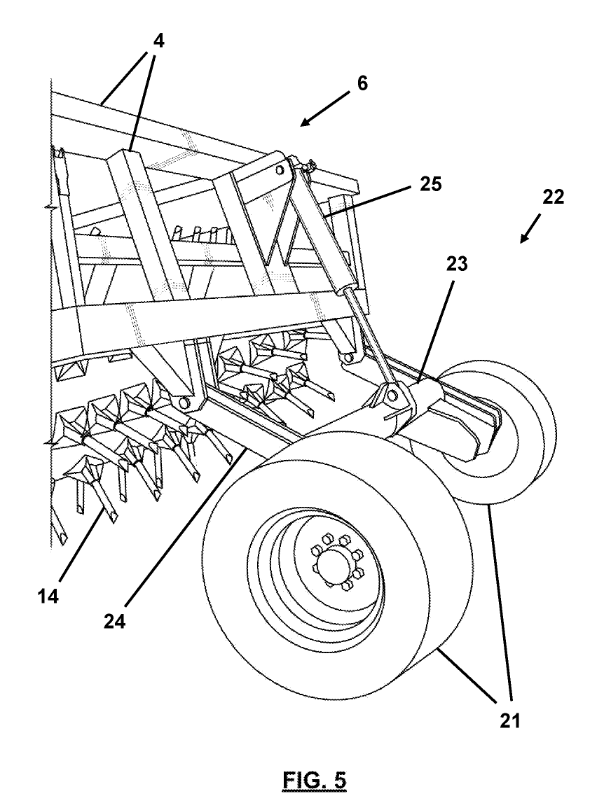

The hardpan apparatus may be made vertically adjustable to selectively vary the depth of penetrating engagement of the spikes 14 with the hardpan subsoil layer. As shown in FIGS. 2 and 5, two height adjustable wheels 21 are attached at the rear end 6 of the frame 2. The wheels 21 may be selectively raised and lowered (with reference to the frame) to adjust the ride height of the frame 2 as it is towed behind a tractor. This may be provided, by way of an adjustable ride height system 22, wherein the wheels 21 are mounted on an axle 23 rotatably supported at one end of a pivoting arm 24. The other end of the pivoting arm 24 is pivotally attached to the rear end 6 of the frame 2. A powered actuator, such as a hydraulic piston 25, is attached to the rear end 6 of the frame 2 and to the pivoting arm 24 to control the angle of the pivoting arm 24 and, thereby, raise and lower the wheels 21. As the wheels 21 are lowered, the frame 2 is thereby raised, and vice versa.

The adjustable ride height system 22 permits the frame 2 to be raised and lowered between a lowered, operative position, and a raised, inoperative position. In the operative position, the wheels 21 are raised and the frame 2 is lowered such that the roller 3 engages the ground and the spikes 14 penetrate the soil, as the hardpan apparatus 1 is pulled behind a tractor. In the inoperative position, the wheels 21 are lowered to make contact with the ground and raise the frame 2 such that the spikes 14 disengage from the ground and remain elevated above and do not make contact therewith.

The ability of the spikes 14 to penetrate the soil and subsoil layers depends primarily on the soil conditions and the total weight of the hardpan apparatus 1. The total weight has three main components: W₁ is the weight of the apparatus itself; W₂ is the weight of the water in the roller 3, if added, and W₃ is the weight of the weights on top of the frame 2, if added. The total weight provides a distributed penetrating force F_{P} on each spike which is engaged with the ground.

During operation, the hardpan apparatus 1 is pulled, in the operative position behind a tractor, over soil with a compacted hardpan layer. The spikes 14 penetrate the soil deeply enough to also penetrate the hardpan layer, but the circumferential face 9 of the roller 3 remains at, or just slightly above the surface of the soil. Accordingly, as the tractor pulls the hardpan apparatus 1, the spikes 14 penetrate the soil, causing the roller 3 to rotate on its rotary bearings 12 within the frame 2. As the roller 3 rotates, the helical rows 16 of spikes 14 make sequential contact with the soil. The spikes 14, continue to rotate and move downwardly through the soil until they reach the hardpan. At this point the spikes 14 will penetrate the hardpan at a downward and forward angle, toward the front end 5 of the frame 2. As the roller 3 continues to rotate, the spikes 14 move through an arc to a downward and rearward angle, toward the rear end 6 of the frame 2. This results in a disruption, or breaking up, of the hardpan layer.

An accessory agricultural implement may be mounted on a rearward extension behind the frame 2 for tandem towing. For example, a harrow rake, may be dragged behind the frame 2 to level and smooth the soil, following disruption of the hardpan. Preferably, two structural members 4 extend rearwardly from the frame 2 with a plurality of chains, or cables, attached therealong. The chains are attached, at one end, to one of the two structural members 4 and at their other end to the harrow rake. The length of the chains is selected to permit the harrow rake to drag along the ground when the frame 2 is in the operative position and to remain elevated above the ground when the frame 2 is in the inoperative position. One or more chains may also be attached at one end to the front end of the harrow rake, and at the other end to the rear end 6 of the frame 2.

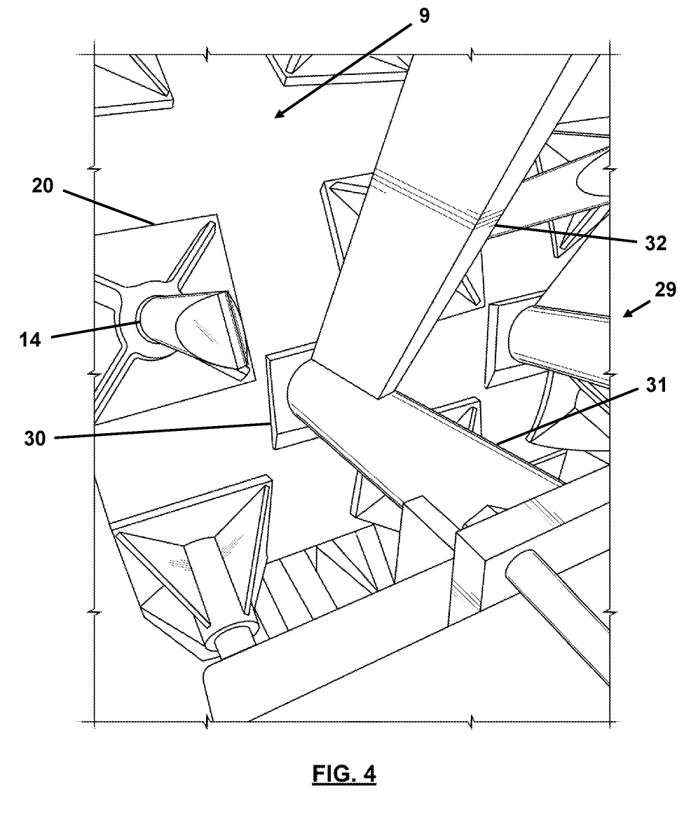

As shown in FIG. 4, scraper devices, or scrapers 29, may be mounted on the frame 2 and positioned between the spikes 14 in each row 16. The scrapers 29 have a scraper blade 30 positioned adjacent the circumferential face 9 of the roller 3 to promote detachment of dirt and debris. The scraper blade 30 is attached to a scraper arm 31 extending from the frame 2 near the rear end 6 thereof. A brace 32 may be attached to the scraper arm 31 near the scraper blade 30 to provide structural support to the scraper arm 31. The scrapers 29 thereby remove dirt and debris from the circumferential face 9 of the roller 3, during operation, which could otherwise build up and prevent the spikes 14 from fully penetrating the soil.

A parking stand 33 may be attached on the front end 5 of the frame 2 to support the weight of the hardpan device 1 and prevent it from tipping forward when not in use. Preferably, the parking stand 33 is located adjacent to the linkage 8 and is hydraulically raised and lowered. The parking stand 33 may also assist in positioning the linkage 8 at the appropriate height to facilitate connection and disconnection with the tractor.

The forgoing description, together with the accompanying figures, set out detail of the structure and function of the present invention, however, the disclosure is to be understood as illustrative of the preferred embodiments and changes may be made without departing from the scope of the invention herein described.

What is claimed is:

1. An apparatus for breaking up the hardpan subsoil layer of agricultural land, comprising:
a wheeled frame adapted to operatively connect to a tractor for towing over the agricultural land;
a roller having a circular cross-section, a length, a circumferential face, and opposing sidewalls rotatably mounted within the frame; and
a plurality of elongated spike members attached to the circumferential face of the roller and extending outwardly therefrom beneath the frame for penetrating engagement with the hardpan subsoil layer.

2. An apparatus, according to claim 1, wherein the plurality of spike members are arranged on the circumferential face in rows between the sidewalls.

3. An apparatus, according to claim 2, wherein the rows are helical rows.

4. An apparatus, according to claim 3, wherein each spike member is fitted within a collar fixedly attached to the circumferential face and attached thereto by means of a shear pin.

5. An apparatus, according to claim 4, wherein each spike member is equidistantly spaced apart from each adjacent spike member in the rows and wherein one or more scraper devices are mounted on the frame and aligned with the equidistant spaces between the spike members having a scraper blade positioned adjacent the circumferential face and spaced apart therefrom.

6. An apparatus, according to claim 5, wherein the frame is vertically adjustable so as to selectively vary the depth of penetrating engagement of the spike members with the hardpan subsoil layer.

7. An apparatus, according to claim 6, wherein the wheels on the frame are mounted on an axle which is pivotally attached to the frame and is vertically adjustable by way of a powered actuator to raise and lower the axle with reference to the frame.

8. An apparatus, according to claim 5, wherein the frame has a rearward extension for supporting one or more agricultural implements for tandem towing behind the apparatus.

9. An apparatus, according to claim 8, wherein the one or more agricultural implements comprise a harrow rake attached to the rearward extension so as to drag along the soil behind the frame.

10. An apparatus, according to claim 5, wherein the frame is adapted to with supports to receive weight ballast.

11. An apparatus, according to claim 5, wherein the roller comprises at least one hollow compartment adapted to receive liquid weight ballast.

12. An apparatus, according to claim 5, wherein the frame comprises a parking stand.
